(19) United States
(12) Patent Application Publication
(10) Pub. No.: US 2011/0269110 A1
(43) Pub. Date: Nov. 3, 2011

(54) Computer-Implemented Systems and Methods for Distributing Constructed Responses to Scorers

(76) Inventor: Catherine McClellan, Pennington, NJ (US)

(21) Appl. No.: 13/099,689

(22) Filed: May 3, 2011

Related U.S. Application Data
(60) Provisional application No. 61/330,661, filed on May 3, 2010.

(51) Int. Cl. G09B 7/00

(52) U.S. Cl. 434/353

(57) ABSTRACT

Systems and methods are provided for distributing constructed responses to scorers to score while reducing an undesirable statistical metric. A constructed response scoring plan is generated, where the scoring plan includes distributing a plurality of constructed responses to scorers for scoring, and where a scoring effectiveness metric is calculated for the scoring plan. An undesirable statistical aspect is identified that has a negative effect on the scoring effectiveness metric. A distribution rule is generated that will reduce the effect of the undesirable statistical aspect on the scoring effectiveness metric. A constructed response queue is generated for a particular scorer based on the distribution rule, and a next constructed response is provided from the constructed response queue to the particular scorer for scoring.

### CROSS REFERENCE TO RELATED APPLICATIONS

This application claims priority to U.S. Provisional Application No. 61/330,661, filed May 3, 2010, entitled “Processor Implemented Systems and Methods for Assigning Prompts and Distributing Constructed Responses to Scorers,” the entirety of which is herein incorporated by reference.

### FIELD

The technology described herein relates generally to constructed response scoring and more particularly to distribution of constructed responses to scorers.

### BACKGROUND

Traditionally, scoring of constructed response exam questions has been an expensive and time consuming endeavor. Unlike multiple choice and true false exams, whose responses can be captured when entered on a structured form and recognized via optical mark recognition methods, more free form constructed responses, such as essays or math questions where a responder must show their work, offer a distinct challenge in scoring. Constructed responses are often graded over a wider grading scale and often involve some scorer judgment as compared to the correct/incorrect determinations that can be quickly made in scoring a multiple choice exam.

Because constructed responses are more free form and are not as amenable to discrete correct/incorrect determinations, constructed responses often require some scorer judgment that may be difficult to automate using computers. Thus, for some constructed responses, human scoring may be preferred. For exams with large numbers of test takers, human scoring has traditionally been performed by convening several scorers in a central location, where constructed responses may be distributed to and scored by one or more scorers. The cost of assembling large numbers of live scorers and distributing large numbers of constructed responses among the live scorers makes for an expensive and often inefficient process. The requirements of maintaining a high level of scoring quality while incorporating appropriate measures for ensuring that scoring biases are prevented further exacerbate these issues.

### SUMMARY

Systems and methods are provided for distributing constructed responses to scorers to score while reducing an effect of an undesirable statistical metric. A constructed response scoring plan may be generated, where the scoring plan includes distributing a plurality of constructed responses to scorers for scoring, and where a scoring effectiveness metric is calculated for the scoring plan. An undesirable statistical aspect may be identified that has a negative effect on the scoring effectiveness metric. A distribution rule may be generated that will reduce the effect of the undesirable statistical aspect on the scoring effectiveness metric. A constructed response queue may be generated for a particular scorer based on the distribution rule, and a next constructed response may be provided from the constructed response queue to the particular scorer for scoring.

As another example, a system for distributing constructed responses to scorers to score while reducing an effect of an undesirable statistical metric may include one or more data processors and a computer-readable medium encoded with instructions for commanding the one or more data processors to execute a method. In the method, a constructed response scoring plan may be generated, where the scoring plan includes distributing a plurality of constructed responses to scorers for scoring, and where a scoring effectiveness metric is calculated for the scoring plan. An undesirable statistical aspect may be identified that has a negative effect on the scoring effectiveness metric. A distribution rule may be generated that will reduce the effect of the undesirable statistical aspect on the scoring effectiveness metric. A constructed response queue may be generated for a particular scorer based on the distribution rule, and a next constructed response may be provided from the constructed response queue to the particular scorer for scoring.

As a further example, a computer-readable medium may be encoded with instructions for commanding one or more data processors to execute a method for distributing constructed responses to scorers to score while reducing an effect of an undesirable statistical metric. In the method, a constructed response scoring plan may be generated, where the scoring plan includes distributing a plurality of constructed responses to scorers for scoring, and where a scoring effectiveness metric is calculated for the scoring plan. An undesirable statistical aspect may be identified that has a negative effect on the scoring effectiveness metric. A distribution rule may be generated that will reduce the effect of the undesirable statistical aspect on the scoring effectiveness metric. A constructed response queue may be generated for a particular scorer based on the distribution rule, and a next constructed response may be provided from the constructed response queue to the particular scorer for scoring.

### BRIEF DESCRIPTION OF THE DRAWINGS

FIG. 1 is a block diagram depicting an example constructed response scoring manager.

FIG. 2 is a block diagram depicting a distribution of constructed responses to scorers.

FIG. 3 is a block diagram depicting the distribution of constructed responses to scorers according to a distribution rule set.

FIG. 4 identifies example rules that may be included in a distribution rule set.

FIG. 5 is a block diagram depicting assignment of constructed responses to scorers using scorer queues.

FIG. 6 is a flow diagram depicting an example algorithm for providing constructed responses to a single scorer for scoring.

FIG. 7 is a flow diagram depicting an example algorithm for distributing constructed responses for scoring a constructed response that is to be scored by two scorers where a scorer pair undue influence rule is implemented.

FIGS. 8A, 8B, and 8C depict example systems for use in implementing a constructed response scoring manager.

FIG. 9 is a flow diagram depicting application of example rules for scoring video of teachers teaching.

FIG. 10 is a flow diagram depicting implementation of a desired demographic profile for scorers.

### DETAILED DESCRIPTION

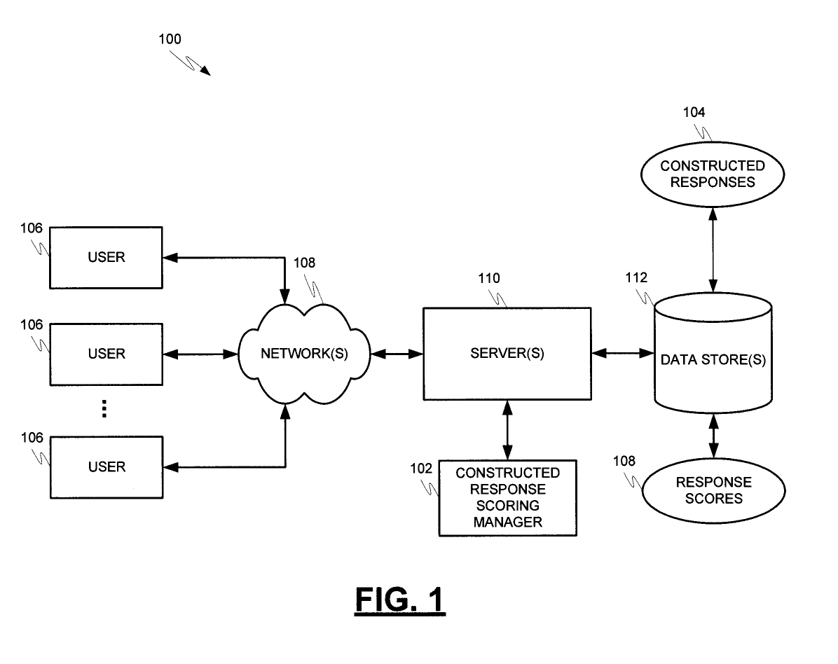

FIG. 1 is a block diagram depicting an example constructed response scoring manager. The constructed response scoring manager 102 manages the scoring of constructed responses 104 by distributing the constructed responses 104 to one or more user scorers 106 over one or more networks 108. The user scorers 106 review the content of constructed responses 104 provided to them and assign response scores 108 to the constructed responses 104 that they receive. The constructed response scoring manager 102 may be implemented using one or more servers 110 responsive to the one or more networks 108. The one or more servers may also be responsive to one or more data stores 112. The one or more data stores 112 may store a variety of data such as the constructed responses 104 and the response scores 108 provided to the constructed responses 104 by the user scorers 106.

Constructed responses may come in a variety of forms. For example, constructed responses may be scanned or text answers to given prompts. Constructed responses may be video recordings of a respondent speaking a response to a prompt. In other scenarios, the constructed response may be a teacher teaching a class. The teacher's teaching ability may be evaluated by one or more scorers as a constructed response.

To alleviate the issues inherent in large scale scoring of constructed responses, computer and computer network technology may be utilized to improve efficiency and lower costs of constructed response scoring. For example, a constructed response scoring system (CRS) may utilize a central database that receives computer-entered or scanned-in constructed responses from exams and distributes those constructed responses to scorers who may not be centrally located. For example, the scorers may be able to score exams from home using their personal computer, where the CRS system provides constructed responses for scoring over a network, such as via a secure Internet connection, and the scorer returns scores for the constructed responses over the same network.

A CRS system can include features related to a number of dimensions of the constructed response scoring workflow. A CRS system can include features related to the recruiting and hiring of question scorers, also known as raters. A CRS system may forecast question scoring based on a number of assigned raters, previous experience of raters, and other factors, and facilitate the scheduling of rater work-times and their access to the CRS system.

A CRS system's end-to-end scoring system can enable the optimization of rater pools to various characteristics, as required by specific scoring programs. Example optimizations include the selection of a specific mix of experienced and new raters, a selection of raters by productivity metrics from previous scoring sessions or performance in certification activities, specific demographic profiles, recency or frequency of previous scoring, and experience on other assessment programs.

A CRS system may be web-based and may provide an easy to use interface that is consistent through both training and actual scoring phases. An integrated training environment provides training in a production like setting to provide an authentic training experience. Certification sets of samples may be provided to a rater to identify the rater's understanding of scoring rubrics and subject knowledge with configurable pass/fail criteria to evaluate whether raters are prepared for actual scoring. Calibration sets may also be provided on pre-scheduled intervals to validate whether raters are following scoring rubrics. The calibration sets may be associated with pass/fail criteria to evaluate that raters are scoring accurately with configurable rules available to address failure of a rater to pass a calibration attempt. Such rules include a requirement to view further training materials or enforcement of a mandatory break period from scoring.

A CRS system's scoring portal may provide a serial pushing of responses to raters for scoring through a web-based infrastructure. Responses can be distributed in single units or folders. Limits may be enforced as to the number of responses a rater may receive from a single test taker with randomized stratification of response distribution being enforced to prevent any bias or undue influence. During scoring, a rater may have access to supporting materials, such as rubrics and sample responses. A windowed interface may enable access to supporting materials without hiding of a response being scored. A rater may hold or defer scoring of individual responses for scoring leader review and may communicate with scoring leaders via chat functionality. The CRS system also provides significant functionality for automatically identifying potential sample responses to questions for use in future training materials.

A CRS system may also offer significant monitoring capabilities enabling real-time observations on scoring progress and quality. Real-time metrics include rater performance data, rater productivity data, scoring quality, and item data. Drill down reporting capability allows metrics to be viewed at multiple levels of rater and item hierarchies. Individual rater performance/productivity statistics can be viewed including completion and results of training, certification, and calibration sets.

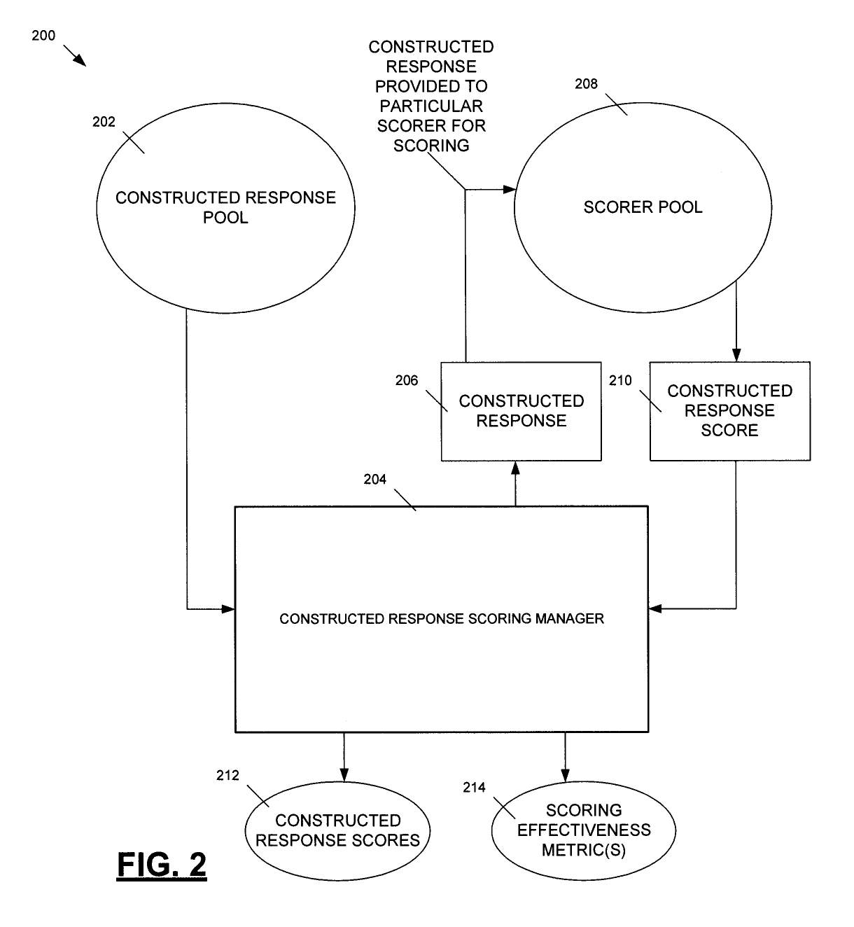

FIG. 2 is a block diagram depicting a distribution of constructed responses to scorers. A number of constructed responses (e.g., responses to essay questions, show-your-work math questions, drafting questions) that need to be scored are contained in a constructed response pool 202. A constructed response scoring manager 204 is responsive to the constructed response pool 202 and accesses the stored constructed responses to provide them to one or more scorers for scoring. Constructed responses in the constructed response pool 202 may be associated with a single prompt, multiple prompts, or multiple different tests. Certain constructed responses may be deemed a higher priority than others. For example, scoring responses from a certain test may be a higher priority than another test. As another example, constructed responses may attain a higher priority level the longer those responses remain in the constructed response pool 202 unscored. The constructed response scoring manager 204 may attempt to distribute the higher priority responses before other normal or low priority responses.

The constructed response scoring manager 204 accesses a particular constructed response 206 and assigns that particular constructed response 206 to a particular scorer from a scorer pool 208. The scorer pool 208 may include a number of scorers who are currently available for scoring (e.g., are online), a number of scorers who are qualified to score constructed responses from the pool of constructed responses 202, or other grouping of scorers. The constructed response scoring manager 204 provides the particular constructed response 206 to a scorer from the scorer pool 208. That scorer reviews the particular constructed response 206 and assigns that particular constructed response 206 a constructed response score 210. The constructed response scoring manager 204 may compile and output assigned constructed response scores 212 in a desired format.

The constructed response scoring manager 204 may also analyze scoring for a particular prompt or particular test to generate one or more scoring effectiveness metrics 214. Scoring effectiveness metrics 214 can relate to a variety of parameters of a particular scoring exercise. For example, a scoring effectiveness metric 214 may be an efficiency metric identifying a rate of scoring for a particular prompt, a particular test, or a particular scorer. The scoring efficiency metric may relate to a bias parameter, such as a measure of whether a particular scorer has scored too large a portion of responses, whether a particular pair of scorers have scored too large a portion of responses in situations where responses are scored by multiple scorers, and other metrics identifying demographics of the scorers providing scores for different prompts or tests.

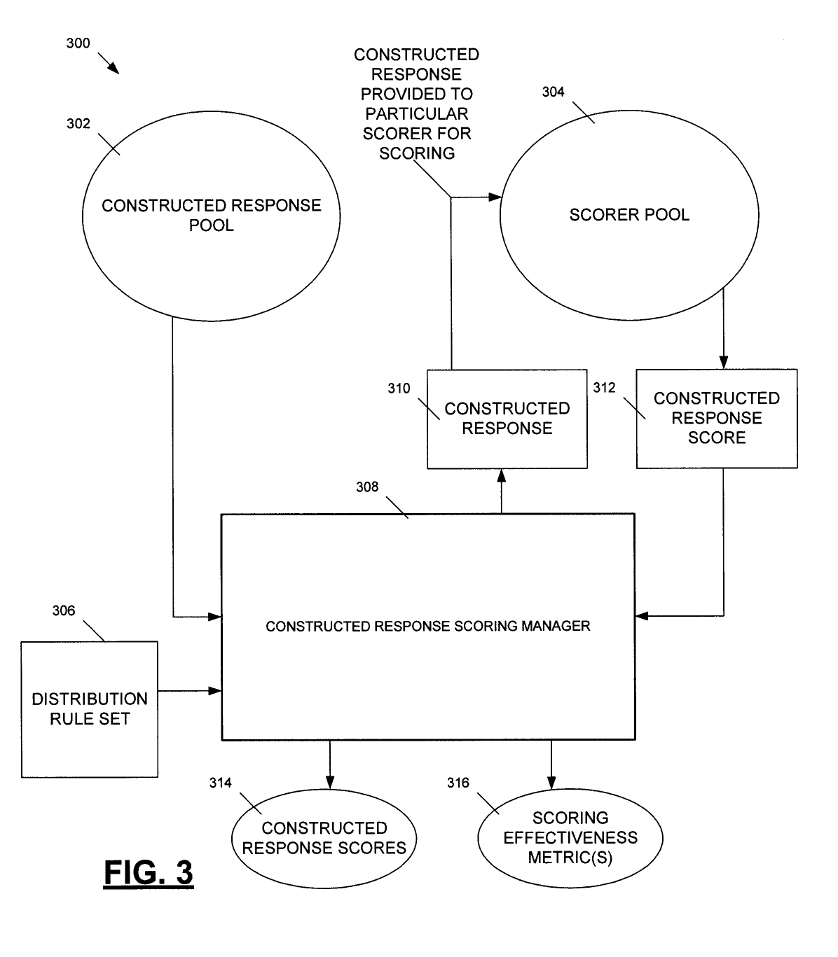

FIG. 3 is a block diagram depicting the distribution of constructed responses to scorers according to a distribution rule set. A constructed response scoring plan is generated. The scoring plan includes distributing a plurality of constructed responses from a constructed response pool 302 to scorers from a scorer pool 304 for scoring. Certain parameters for the scoring may be identified as part of generating the constructed response plan. These parameters may take a variety of forms. For example, parameters may pertain to time period requirements for scoring the constructed responses, demographic requirements of scorers of the constructed responses (e.g., a scorer may not be from the same county as a respondent associated with a particular constructed response, more than a threshold proportion of women scorers must score constructed responses for a particular prompt, certain bias parameters must not meet predetermined bias thresholds [Feel free to add others here]).

To meet the desired parameters for the constructed response scoring plan, one or more distribution rules may be developed as part of a distribution rule set 306. The distribution rule set 306 may be provided to the constructed response scoring manager 308 for use in distributing constructed responses to scorers for scoring. For example, one or more rules may be generated to reduce an undesirable statistical metric such as a bias parameter that measures bias generated in multiple scorer scenarios when a particular pair of scorers scores a particularly high portion of the constructed response. The example rule may limit the number of times that particular pair of raters may be selected to avoid having the bias parameter exceed the scoring plan parameter.

Scoring rules may be automatically generated by a constructed response scoring manager 308 or may be designed by a third party such as a test requirements technician. The scoring rules may be generated to reduce the effect of an undesirable statistical aspect on a scoring effectiveness metric. For example, scoring rules may be generated to reduce the effect of bias caused by a particular pair of scorers scoring too large a portion of a set of constructed responses. The scoring rules may limit the number of constructed responses a particular pair of scorers may score. By limiting the number of constructed responses a particular pair of scorers may score, a scoring effectiveness metric related to bias may be improved based on the limited scoring pair undue influence effect.

The constructed response scoring manager 308 may receive the distribution rule set 306 and apply the received rules in assigning constructed responses to scorers. For example, a particular constructed response 310 may be selected by the constructed response scoring manager. In assigning the particular response 310 to a particular scorer, the constructed response scoring manager 308 may review the distribution rule set 306 to determine if assigning the particular constructed response 310 to the particular scorer is appropriate. If such an assignment is not appropriate, then the particular constructed response 310 may be assigned to another scorer.

The scorer who receives the particular constructed response 310 reviews the response and provides a constructed response score 312. The constructed response scoring manager 308 compiles and outputs the constructed response scores 314. The constructed response scoring manager 308 may also evaluate the scoring of constructed responses to calculate one or more scoring effectiveness metrics 316. By applying the distribution rule set 306 to the constructed response distribution, the constructed response scoring manager 308 attempts to achieve the desired parameters of the scoring plan. The effectiveness of this attempt may be highlighted by the scoring effectiveness metrics 316.

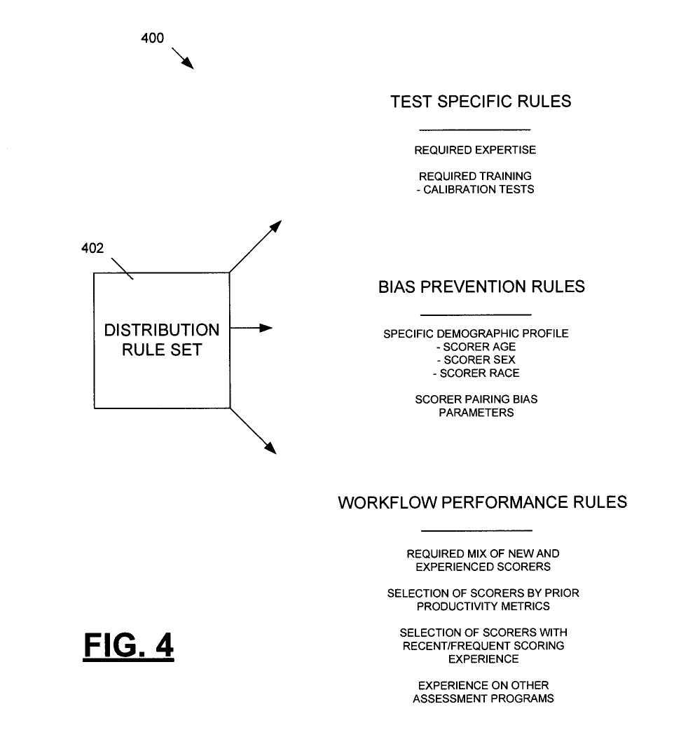

FIG. 4 identifies example rules that may be included in a distribution rule set. A distribution rule set 402 may include test specific rules. Test specific rules may be specifically associated with constructed responses for a particular test. The test specific rules may be designed by the testing authority or may be designed based on testing authority design parameters. Test specific rules may include a level of or certain experience that is required for a scorer to be eligible to score certain constructed responses. Other test specific rules may include required training that a scorer must attend. The effectiveness of that training may be examined using periodic calibration tests that examine a scorer's ability to properly apply scoring rubrics for evaluating constructed responses.

The distribution rule set 402 may also include bias prevention rules. Bias prevention rules may include criteria of individual or overall demographics for scorers for a particular constructed response or particular test. For example, an average scorer age may be required to be within a particular range. As another example, a certain proportion of scorers may be required to be men or a certain race. As another example, for constructed responses to be scored by two or more scorers, a bias prevention rule may require that no more than a certain percentage of constructed responses be scored by a particular pair of scorers.

The distribution rule set 402 may also include workflow performance rules. To better regulate promptness of scoring, a required mix of new and experienced scorers may be enforced. As another example, scorers may be selected by prior productivity metrics associated with individual scorers. Scorers may also be selected based on similar recent or frequent scoring, as well as those scorers' performance reviews for other scoring projects.

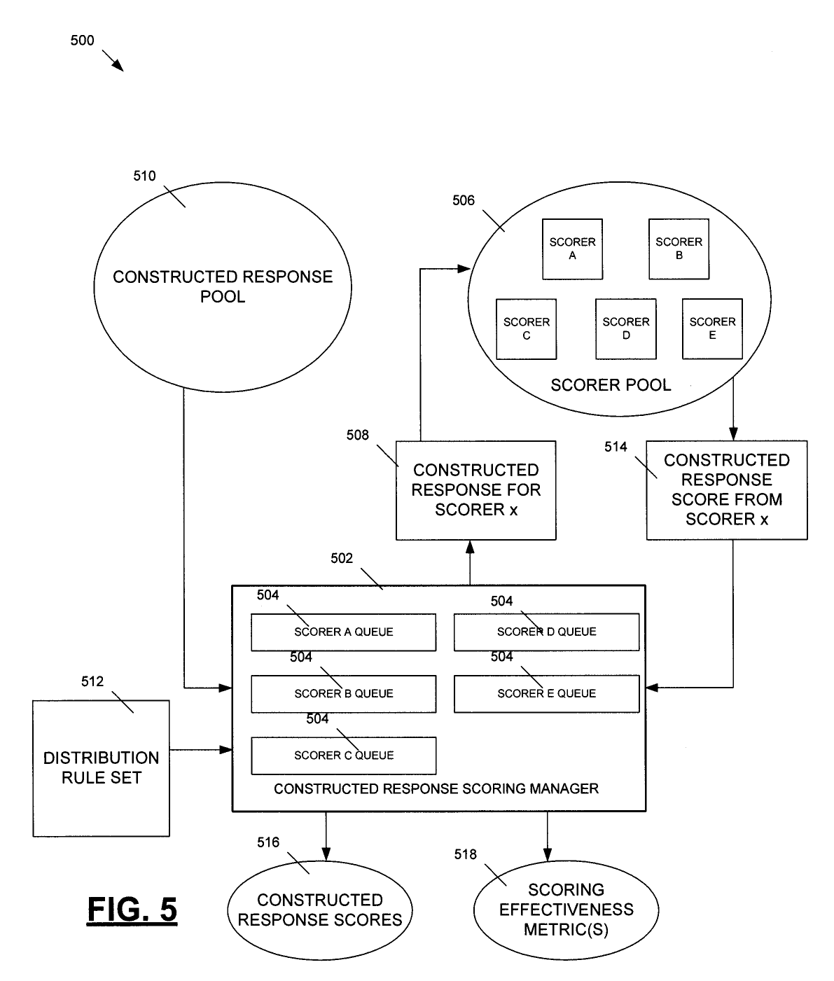

FIG. 5 is a block diagram depicting assignment of constructed responses to scorers using scorer queues. A constructed response scoring manager 502 may distribute responses to scorers using scorer queues 504. A constructed response scoring manager 502 may generate and maintain a scoring queue 504 for each scorer in a scorer pool 506. A particular constructed response 508 from the constructed response queue 510 reaching the front of a queue 504 for a particular scorer may be provided to that particular scorer as long as providing that particular response 508 to the particular scorer does not violate any rules from the distribution rule set 512.

A scorer queue 504 may be generated for a particular scorer based on one or more rules from the distribution rule set 512. For example, a distribution rule may dictate that a scorer who is from the same state as a respondent may not score constructed responses for that respondent. Thus, when generating the scorer queue for Scorer A, the constructed response pool may be filtered according to that distribution rule to prohibit any constructed responses from same state respondents from appearing in the scorer queue for Scorer A.

In addition to evaluating distribution rules when populating scorer queues 504, the constructed response scoring manager 502 may evaluate distribution rules before distributing a constructed response from to a particular scorer from the scoring queue of that particular scorer. For example, if a distribution rule dictates that a scorer pair may not evaluate more than 20 constructed responses from the constructed response pool, then the constructed response scoring manager 502 may evaluate prior scorers for a particular constructed response at the front of a scorer queue before distributing that constructed response. For example, if the pair of Scorer B and Scorer D has already evaluated 20 responses, and a particular response appears at the front of Scorer D's queue that has already been scored by Scorer B, then the constructed response scoring manager may prevent the particular response from being assigned to Scorer D. The particular response may be removed from Scorer D's scorer queue, and the next response in Scorer D's scoring queue may be available.

The scorer who receives the particular constructed response 508 reviews the response and provides a constructed response score 514. The constructed response scoring manager 502 compiles and outputs the constructed response scores 516. The constructed response scoring manager 502 may also evaluate the scoring of constructed responses to calculate one or more scoring effectiveness metrics 518.

In another implementation, a constructed response scoring manager may manage one scorer queue that is shared across all scorers in a scorer pool. In such an implementation, a scorer who is available to score a constructed response may request a constructed response. The next constructed response in the general scorer queue may be analyzed according to the distribution rules to determine if the next constructed response in the queue is appropriate for the requesting scorer. If the next constructed response is appropriate, then the next constructed response is provided to the scorer. If the next constructed response in the queue is not appropriate, then a subsequent response in the queue may be considered.

In some implementations, distribution rules may be assigned a priority level. For example, some distribution rules may be deemed mandatory while other distribution rules are only preferable. In some implementations, a constructed response scoring manager may relax certain distribution rules to enable continued distribution of constructed responses for scoring. For example, a particular set of distribution rules may deadlock a system such that no constructed responses may be assigned without breaking at least one distribution rule. In such a scenario, the constructed response scoring engine may relax a lower level rule and re-attempt distribution of constructed responses. If the system remains deadlocked, additional distribution rules may be temporarily relaxed according to rule priority to enable continuation of the scoring process.

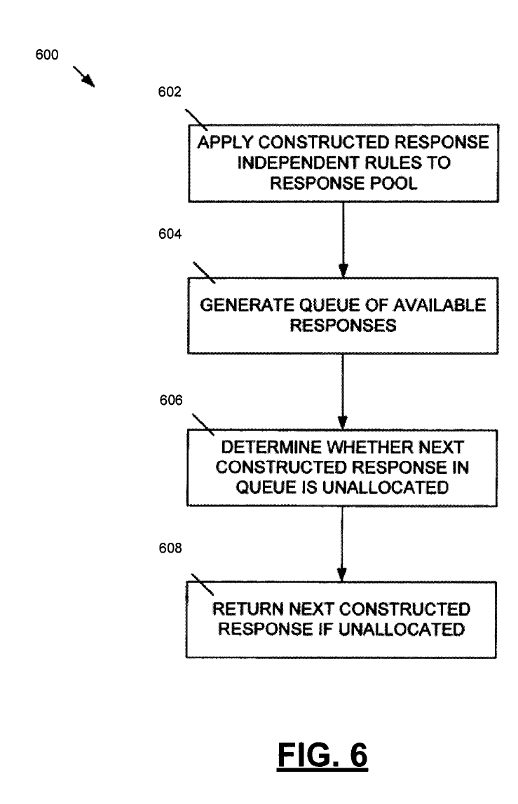

FIG. 6 is a flow diagram depicting an example algorithm for providing constructed responses to a single scorer for scoring. One or more constructed response independent rules may be applied to a plurality of constructed responses in a response pool at 602. For example, rules preventing undue influence for a single scorer on a certain question may be applied to prevent the single scorer from scoring more than a certain percentage of constructed responses for a single prompt. A queue is generated at 604 that is populated with constructed responses that remain after the application of constructed response independent rules at 602. At 606, the next constructed response in the queue is evaluated to determine if that constructed response has been allocated to the total number of scorers scheduled to score that constructed response. For example, if the next constructed response is to be scored by three scorers and has already been allocated to be scored by three scorers, then the determination at 606 will identify the next constructed response as allocated, and the following response with be evaluated at 606. If the next constructed response has been assigned to fewer than the number of scheduled scorers, then the next constructed response is determined to be unallocated. Upon finding a next constructed response that is unallocated, the next constructed response is returned to a scorer for scoring at 608.

More sophisticated rules may also be implemented. For example, in an environment where a constructed response is to be scored by two scorers, a distribution rule may be implemented that prevents a pair of two scorers from being assigned to more than a particular number of constructed responses. Such a distribution rule could be implemented in a number of ways. For example, a constructed response may be provided to a first scorer for scoring. Following scoring by the first scorer, the constructed response may be tentatively assigned to a second scorer for scoring. Before the constructed response is provided to the second scorer for scoring, a check may be implemented to determine the number of times the pair of scorers (i.e., the first scorer and the second scorer) have been the two scorers for constructed responses (e.g., for the current prompt, for the current test, during a particular time period). If the determined number of times exceeds a threshold, then the constructed response may be unassigned from the second scorer and assigned to a different scorer for second scoring.

In an example algorithm for determining the maximum threshold, Raterₘₐₓ is the amount that a pair of raters rater are assumed to be in error on average, maximum. Pool_{inf} is the amount of influence on the pool of scores that a pair of raters is permitted to have during a given time period. Assuming all raters except the target pair of raters score exactly according to the scoring rubric so that no influence except from the rater pair of concern is considered, then:

$${Pool}_{inf} = \frac{{Rater}_{ma x} * {N}_{reponse / rater}}{{N}_{reponse / total} } ; and$$

$${N}_{response / rater} = \frac{{Pool}_{inf} * {N}_{response / total}}{{Rater}_{ma x}} .$$

The number of total responses N_{responses/total} is known for a scoring shift or overall total, and the values of Raterₘₐₓ and Pool_{inf} are values that are provided which may be based on empirical data from past similar examinations.

As an example, in a Praxis administration for 2,000 candidates responding to a four constructed response test that is double scored, for each item, there are 2,000 scores to be assigned by rater pairs. Assuming a 4 point scale, it may be determined that a single rater pair is not expected to be more than 0.5 points off of the scoring rubric and that the pool influence of a single rater pair can be no more than 0.05 points. The number of responses that a single rater pair may score may then be determined as:

$${N}_{responses / rater} = \frac{{Pool}_{inf} * {N}_{response / total}}{{Rater}_{ma x}} = \frac{0.05 * 4000}{0.5} = 400.$$

As another example, for a GRE scoring session, where GRE scores are being scored continuously, such that there is no “total number of scores,” for a four hour scoring shift, there is an expected number of scores to be assigned of 2,500. A six level scoring scale is assumed, and it is assumed that a single rater pair will be no more than one point off rubric. A Pool_{inf} value of 0.01 points is set. The number of responses that a single rater pair may score may then be determined as:

$${N}_{response / rater} = \frac{{Pool}_{inf} * {N}_{response / total}}{{Rater}_{ma x}} = \frac{0.01 * 2500}{1.0} = 25.$$

The above described algorithm and formula for preventing undue influence for a rater pair may also be utilized for a single rater, where N_{responses/rater} is the maximum number of responses that a single rater may score, P_{inf} is the maximum amount of influence that a single rater is permitted to have on the pool during a period, and Raterₘₐₓ is the amount a single rater is assumed to be off on scoring on average, minimum.

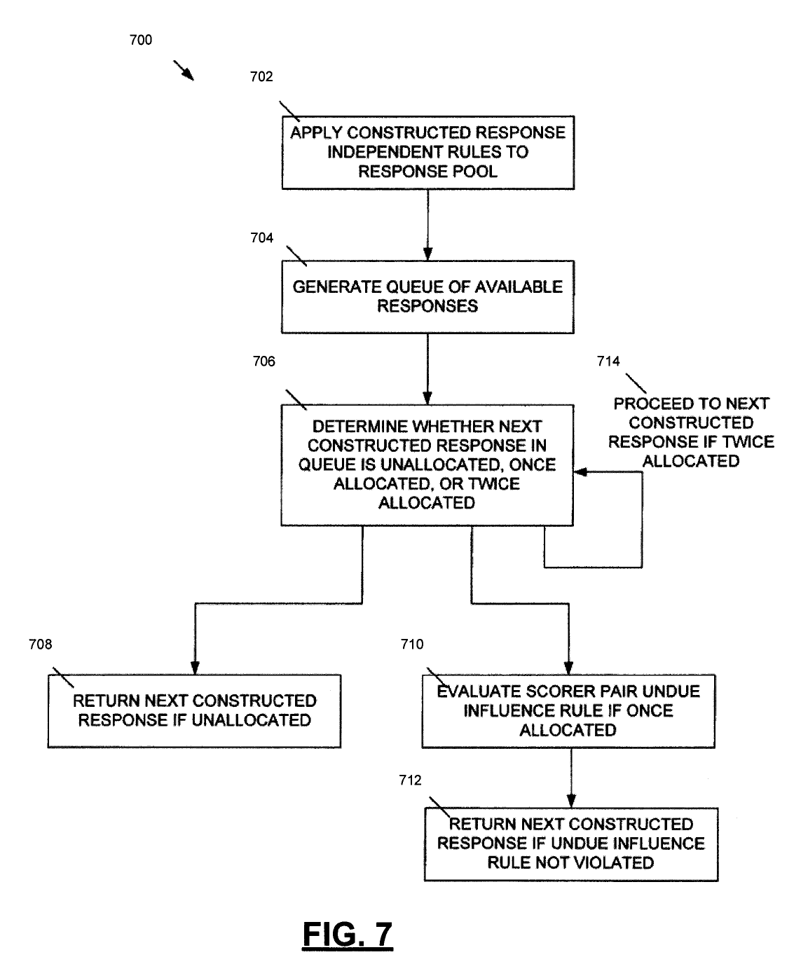

FIG. 7 is a flow diagram depicting an example algorithm for distributing constructed responses for scoring a constructed response that is to be scored by two scorers where a scorer pair undue influence rule is implemented. At 702, constructed response independent rules are applied to the response pool, and at 704, a queue is generated from the constructed responses available after application of the constructed response independent rules. At 706, a determination is made as to whether the next constructed response in the queue is unallocated, once allocated, or twice allocated. If the next constructed response is unallocated, then the next constructed response is returned to the scorer for scoring at 708.

If the next constructed response has been once allocated, then a scorer pair undue influence rule is evaluated at 710. The scorer pair undue influence rule evaluation can be based on the first scorer to whom the next constructed response has already been allocated and the current scorer who is currently requesting a constructed response, as described herein above. If the undue influence rule is not violated by assigning the next constructed response to the current requesting scorer, then the next constructed response is assigned to the current requesting scorer at 712.

If the next constructed response has been twice allocated already, where the next constructed response is to be scored by two scorers, then there is no need for the current requesting scorer to score the response for a third time, and the queue is moved forward one position, as indicated at 714.

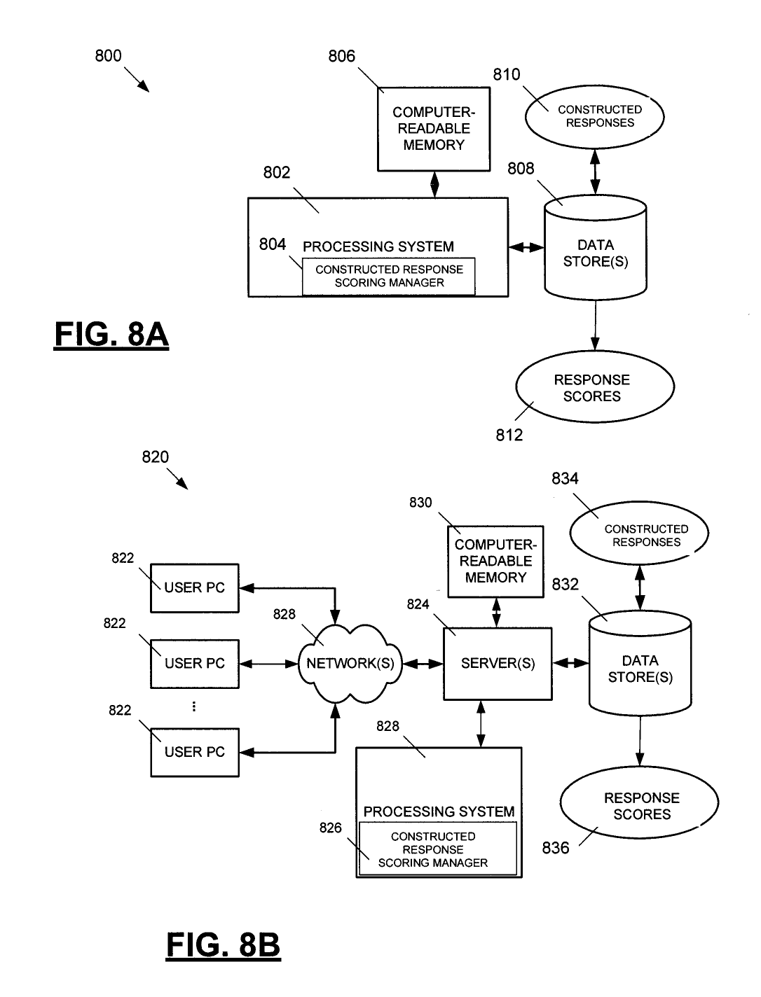

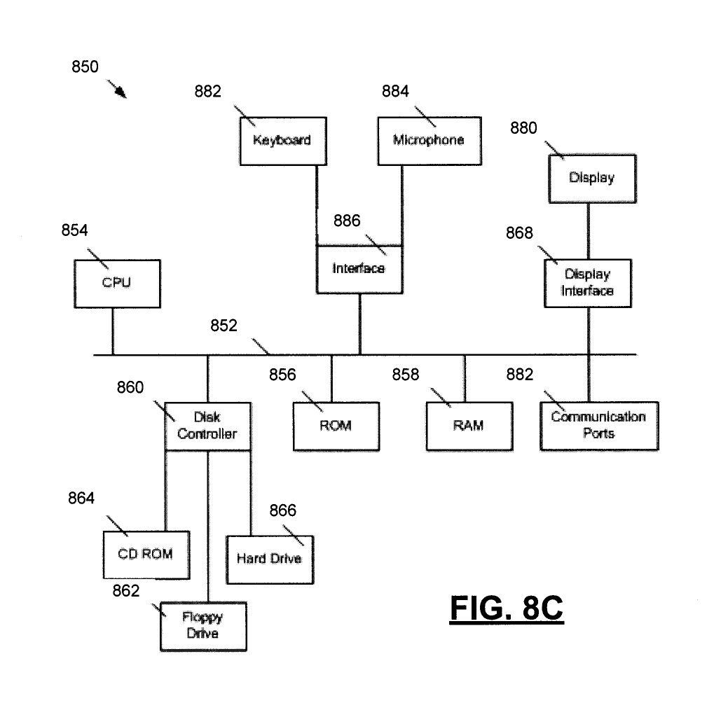

FIGS. 8A, 8B, and 8C depict example systems for use in implementing a constructed response scoring manager. For example, FIG. 8A depicts an exemplary system 800 that includes a stand alone computer architecture where a processing system 802 (e.g., one or more computer processors) includes a constructed response scoring manager 804 being executed on it. The processing system 802 has access to a computer-readable memory 806 in addition to one or more data stores 808. The one or more data stores 808 may include constructed responses 810 as well as response scores 812.

FIG. 8B depicts a system 820 that includes a client server architecture. One or more user PCs 822 accesses one or more servers 824 running a constructed response scoring manager 826 on a processing system 827 via one or more networks 828. The one or more servers 824 may access a computer readable memory 830 as well as one or more data stores 832. The one or more data stores 832 may contain constructed responses 834 as well as response scores 836.

FIG. 8C shows a block diagram of exemplary hardware for a standalone computer architecture 850, such as the architecture depicted in FIG. 8A that may be used to contain and/or implement the program instructions of system embodiments of the present invention. A bus 852 may serve as the information highway interconnecting the other illustrated components of the hardware. A processing system 854 labeled CPU (central processing unit) (e.g., one or more computer processors), may perform calculations and logic operations required to execute a program. A processor-readable storage medium, such as read only memory (ROM) 856 and random access memory (RAM) 858, may be in communication with the processing system 854 and may contain one or more programming instructions for performing the method of implementing a constructed response scoring manager. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 860 interfaces one or more optional disk drives to the system bus 852. These disk drives may be external or internal floppy disk drives such as 862, external or internal CD-ROM, CD-R, CD-RW or DVD drives such as 864, or external or internal hard drives 866. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 860, the ROM 856 and/or the RAM 858. Preferably, the processor 854 may access each component as required.

A display interface 868 may permit information from the bus 856 to be displayed on a display 870 in audio, graphic, or alphanumeric format. Communication with external devices may optionally occur using various communication ports 872.

In addition to the standard computer-type components, the hardware may also include data input devices, such as a keyboard 872, or other input device 874, such as a microphone, remote control, pointer, mouse and/or joystick.

Many different types of rules may be implemented by a constructed response scoring manager. For example, a rule may be implemented to control the portion of variance that is attributable to unintended increased score variability that is caused by raters viewing a homogenous group of responses in a row. For example, in general, responses from different regions will tend to be similar to each other. Test takers from different states or regions might tend to answer a response similarly because of the curriculum and instruction in that state or region. The similarity may lead to responses tending to have, on average, stronger or weaker responses than the pool or responses as a whole. Raters expect to see responses representing the range of score points over the course of scoring. If raters score a large group of responses from the same region, that, legitimately, should be assigned the same score point (or in the same range of score points), the rater might begin to look for differences among the responses that do not exist. By doing so, raters are likely to award either higher or lower score points than a response might truly deserve, in order reduce the dissonance between the observed homogenous set of responses they score, and the expectation that they should be assigning score points at many different levels. Their perception of the quality of a response is affected by the relative quality of the other responses that are scored in close proximity to it. As a comparable analogy, when a person puts their hand in tepid water after a prolonged period of time in very cold water, the tepid water is perceived as very hot.

Random distribution of responses may make long consecutive strings of responses from the same region an unlikely occurrence; however, it does not explicitly prevent them from occurring. Thus, a rule may be implemented to prevent prolonged sequences of responses that are similar to each other will help prevent the rater errors in judgment that might occur as a result. An example rule may allow no more than n responses consecutively from a given region (e.g., as defined by the country code associated with the response) for any rater.

To implement this rule, a constructed response scoring manager may be able to access and use a variable that defines the variable thought to capture homogeneous groups (e.g., region/country/test center). The constructed response scoring manager may be able to count how many responses (e.g., in a row) a rater has scored with the same value of the target variable. When appropriate, a constructed response scoring manager may be able to treat multiple variable values as one group (e.g., multiple test centers represent one region collectively) in counting. The constructed response scoring manager may be able to compare the count to a pre-specified limit, n, and the constructed response scoring manager may be able to reset the counter each time a response is assigned with a different value from the target variable.

In practice, when the first response is distributed to a rater, a counter is incremented by 1 to indicate that one response from that region has been assigned. When the rater requests the next response, the system checks to make sure that the counter has not reached n, and counter is incremented by 1 if the response is from the same region as the first response, and is reset to 1 if the response is from a different region. When the counter reaches n, the system must choose a response from another region to allocate to that rater, and the counter is reset to 1.

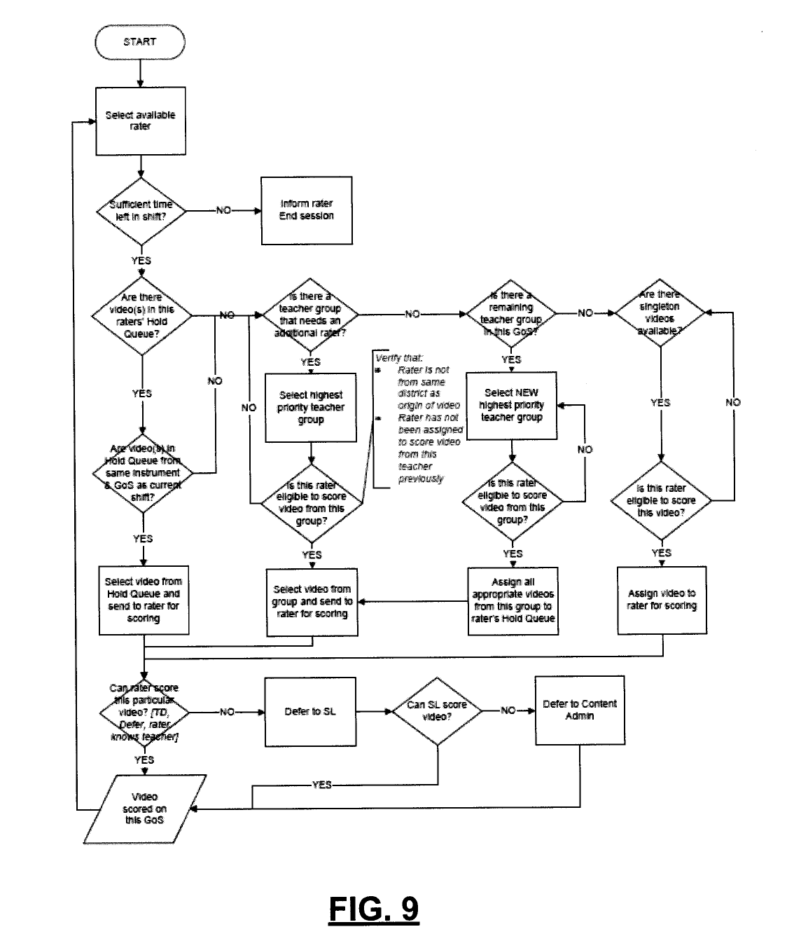

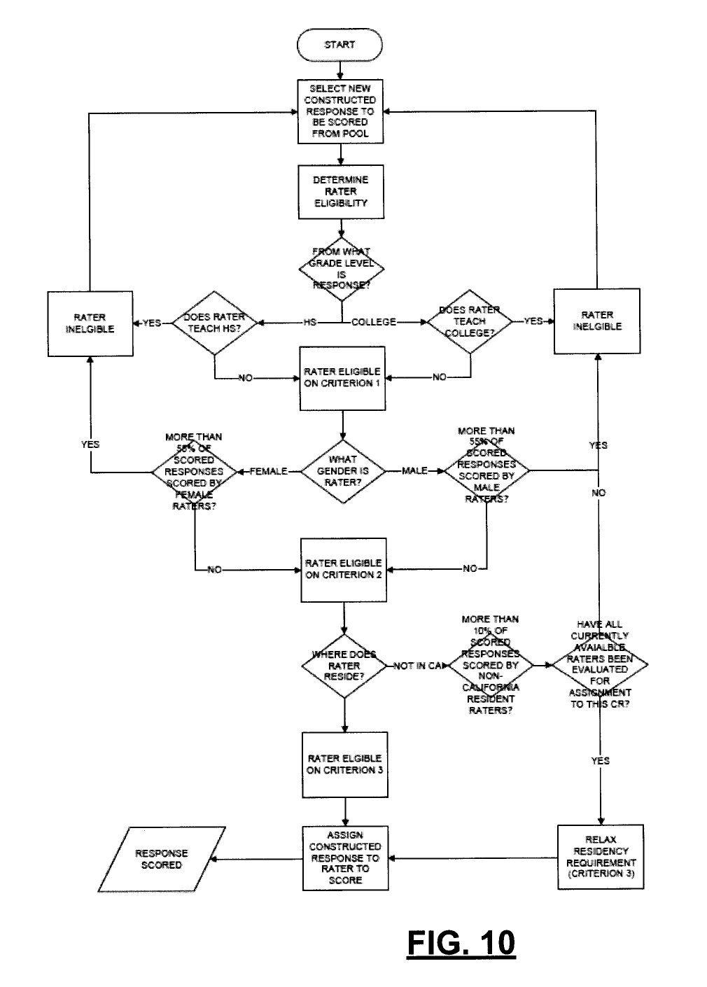

As another example, FIG. 9 is a flow diagram depicting application of example rules for scoring video of teachers teaching. In the example of FIG. 9, the scoring type is video. Teachers to be scored exist in groups designed so that teachers are “interchangeable” by definition outside of the system. Teacher groups have from 1 to N members, and each teacher group member has 1 to 10 videos.

The example of FIG. 9 seeks to control a component of variance due to individual rater effects so that an assumption of constant value within teacher group can be supported. The example simultaneously minimizes a component of variance due to repeat ratings by the same rater (“halo effect”) by maximizing the number of raters scoring an individual teacher's videos. The example eliminates component of variance due to rater having personal knowledge of teacher to be scored.

Thus, each individual teacher's videos will be scored by different raters; this will minimize variance due to repeat ratings. Within a teacher group, each teacher will be rated by the same fixed set of raters, supporting an assumption of constant rater effects across the teacher group. Teacher videos will not be scored by a rater who has taught or worked in the teacher's district of employment (LEA) within the last 5 years, eliminating rater bias due to prior knowledge of candidate.

A constructed response scoring manager may be able to access and use a variable that defines the “teacher group.” The manager may have access to district of employment information for each teacher and collect information about raters' employment history for prior 5 years. The manager may be able to determine an amount of remaining time in raters' current shift, and the manager may be able to compare remaining shift time to anticipated video scoring time and determine sufficiency of time to score. A manager may have capability to assign a group of videos to an individual rater in a “Hold Queue” based on rules defining qualification to score. A manager may have capacity to release videos from a rater Hold Queue based on time resident in that queue and reassign videos to an alternate qualified rater. The manager may have capability to create a temporary set of raters (independent of working shift team assignments) and retain information on this set until scoring is complete. The manager may have capacity to prioritize teacher groups by ID or other available data, and the manager may have capability to assign teacher groups of videos to be scored on multiple instruments and multiple Groups of Scales (GoS) within an instrument.

As a further example, FIG. 10 is a flow diagram depicting implementation of a desired demographic profile for raters. Such a process may be utilized when a client of an assessment has specified a profile for the scored data pool in terms of the demographics of the raters assigning the scores.

The process seeks to control a component of variance due to effect of teaching at same schooling level as that of the response submitter. The process seeks to balance the gender of raters completing scoring within 5% of 50% of each gender in order to control any gender bias in scoring due to specific material assessed. The process seeks to limit a component of rater variance associated with unfamiliarity with specific content assessed by permitting no more than 10% of raters to be non-residents of California at time of scoring.

Rater assignment to score constructed responses is to be balanced so that the rater is a teacher from a different level of educational institute than that of the respondent (e.g., high school or college). The process seeks to achieve a balance of male and female raters so that the maximum discrepancy in proportion between genders in the raters who assign scores is 0.10. Assuming content specific to a California curriculum, the process controls a component of rater bias due to lack of familiarity with the curricular materials by limiting scores assigned by raters not resident in California to a maximum of 10%. The constraint of California residency is considered to be desirable, but may be relaxed if necessary to complete scoring; the other constraints are considered absolute and may not be relaxed.

The constructed response scoring manager may be able to access and use demographic data on rater profile, including level of educational institution rater is currently teaching at, gender of rater, and current residency of rater. The manager may maintain proportional accounting of the scored response pool so that required constraints are met in term of scores assigned by raters with various demographic characteristics. The manager may be able to evaluate rater availability against residency criterion and determine if an alternate eligible rater is available in the pool. If not, the manager may be capable of relaxing that constraint and re-assessing eligibility against the two constraints that are absolute.

As additional examples, for example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method of distributing constructed responses to scorers to score while reducing an effect of an undesirable statistical metric, comprising:
generating a constructed response scoring plan, wherein the scoring plan includes distributing a plurality of constructed responses to scorers for scoring, wherein a scoring effectiveness metric is calculated for the scoring plan;
identifying an undesirable statistical aspect that has a negative effect on the scoring effectiveness metric;
receiving a distribution rule that will reduce the effect of the undesirable statistical aspect on the scoring effectiveness metric;
generating a constructed response queue for a particular scorer based on the distribution rule; and
providing a next constructed response from the constructed response queue to the particular scorer for scoring.

2. The method of claim 1, wherein the constructed response scoring plan includes more than one scorer scoring a single constructed response.

3. The method of claim 2, wherein the undesirable statistical aspect is based on a particular group of scorers scoring a large portion of the plurality of constructed responses.

4. The method of claim 1, wherein the constructed response scoring plan includes a pair scorers scoring a single constructed response, wherein the undesirable statistical aspect is based on a particular pair of scorers scoring too large of a portion of the plurality of constructed responses.

5. The method of claim 4, further comprising determining whether the next constructed response in the constructed response is unallocated, once allocated, or twice allocated.

6. The method of claim 5, wherein the next constructed response is provided to the particular scorer when the next constructed response is unallocated.

7. The method of claim 6, further comprising evaluating an undue influence rule if the next constructed response is once allocated.

8. The method of claim 7, wherein the undue influence rule determines whether the particular scorer is permitted to score the next response based on an identity of a second particular scorer who has already scored the next response.

9. The method of claim 8, wherein the particular scorer is not permitted to score the next response if the particular scorer and the second particular scorer have scored more than a threshold number of constructed responses.

10. The method of claim 9, wherein the next response is removed from the constructed response queue when the particular scorer is not permitted to score the next response.

11. The method of claim 1, further comprising determining whether the next constructed response in the constructed response queue is unallocated prior to providing the next constructed response to the particular scorer.

12. The method of claim 1, wherein the constructed response is a video of a teacher teaching, wherein the undesirable effect is caused by a scorer scoring the same teacher multiple times, wherein the distribution rule requires a particular group of scorers score a particular group of teachers, with no scorer scoring a single teacher multiple times.

13. The method of claim 1, wherein the distribution rule prevents a scorer from scoring more than a threshold number of constructed responses from a particular region in a row.

14. A computer-implemented system for distributing constructed responses to scorers to score while reducing an effect of an undesirable statistical metric, the system comprising:
one or more data processors;
a computer-readable memory encoded with instructions for commanding the one or more data processors to execute steps including:
generating a constructed response scoring plan, wherein the scoring plan includes distributing a plurality of constructed responses to scorers for scoring, wherein a scoring effectiveness metric is calculated for the scoring plan;
identifying an undesirable statistical aspect that has a negative effect on the scoring effectiveness metric;
receiving a distribution rule that will reduce the effect of the undesirable statistical aspect on the scoring effectiveness metric;
generating a constructed response queue for a particular scorer based on the distribution rule; and
providing a next constructed response from the constructed response queue to the particular scorer for scoring.

135. The system of claim 14, wherein the constructed response scoring plan includes a pair scorers scoring a single constructed response, wherein the undesirable statistical aspect is based on a particular pair of scorers scoring too large of a portion of the plurality of constructed responses.

16. The system of claim 15, wherein the steps further include determining whether the next constructed response in the constructed response is unallocated, once allocated, or twice allocated.

17. The system of claim 16, wherein the next constructed response is provided to the particular scorer when the next constructed response is unallocated.

18. The system of claim 17, wherein the steps further include evaluating an undue influence rule if the next constructed response is once allocated.

19. The system of claim 18, wherein the undue influence rule determines whether the particular scorer is permitted to score the next response based on an identity of a second particular scorer who has already scored the next response.

20. A computer-readable memory encoded with instructions for commanding one or more data processors to execute method of distributing constructed responses to scorers to score while reducing an effect of an undesirable statistical metric, the method comprising:
generating a constructed response scoring plan, wherein the scoring plan includes distributing a plurality of constructed responses to scorers for scoring, wherein a scoring effectiveness metric is calculated for the scoring plan;
identifying an undesirable statistical aspect that has a negative effect on the scoring effectiveness metric;
receiving a distribution rule that will reduce the effect of the undesirable statistical aspect on the scoring effectiveness metric;
generating a constructed response queue for a particular scorer based on the distribution rule; and
providing a next constructed response from the constructed response queue to the particular scorer for scoring.
